(19) United States
(12) Patent Application Publication
(10) Pub. No.: US 2004/0018952 A1
(43) Pub. Date: Jan. 29, 2004

(54) Triggered response compositions

(76) Inventors: Richard Thomas Gray, Levittown, PA (US); Barry Weinstein, Dresher, PA (US)

Correspondence Address: ROHM AND HAAS COMPANY, PATENT DEPARTMENT, 100 INDEPENDENCE MALL WEST, PHILADELPHIA, PA, 19106-2399, US

(21) Appl. No.: 10/619,061

(22) Filed: Jul. 14, 2003

Related U.S. Application Data
(60) Provisional application No. 60/398,415, filed on Jul. 25, 2002.

(51) Int. Cl. C11D 3/37

(52) U.S. Cl. 510/476

(57) ABSTRACT

This invention provides a triggered response composition in the form of a barrier material and a delivery device that includes one or more polyelectrolytes in contact with an aqueous system that is stable and insoluble in an aqueous system and that exhibits one or more chemical/physical responses in the aqueous system, wherein the chemical/physical response of the composition is triggered upon a change of the chemical/physical properties in the aqueous system.

The present invention relates to compositions that are capable of producing a chemical or physical response that is triggered upon exposing the compositions to an aqueous system containing one or more or a series of triggering events, each triggering event encompassing a chemical/physical process or property. In particular, it relates to regulating the stability of polyelectrolyte compositions in an aqueous system by triggering events in the aqueous system that result in the dissolution, degradation, swelling or dispersion of the polyelectrolyte compositions at a specified time, the triggering events brought about by marked alterations in ionic strength and those in addition to ionic strength including: dilution, pH, temperature, mechanical forces and combinations thereof. The present invention is further directed to barrier materials surrounding triggered responsive compositions useful for the delivery of active ingredients and beneficial agents in an aqueous system to an environment of use.

It is often desirable to provide compositions and devices that deliver or provide controlled release of one or more active ingredients/beneficial agents to an environment of use. Especially in fabric care applications, compositions containing various types of active ingredients in addition to detergents are sought as well as the controlled delivery of such active ingredients/beneficial agents.

International Publication Patent No. WO 00/17311 discloses a coated a detergent active encapsulated with a coating material which enabling a delayed release of the detergent active in to a washing solution, the coating material being insoluble in a washing solution having a pH equal to or greater than 10 at 25° C., yet being soluble in a washing solution having a pH equal to or less than 9 at 25° C. The coating materials disclosed include amines, waxes, Schiff base compounds and mixtures thereof U. S. Patent Application Publication No. 2001/0031714 A1 discloses a laundry detergent portion having two or more detersive components of which at least two are released into the wash liquor at different times, the portion including at least one temperature or pH switch to provide controlled release of the detersive components. The switch materials disclosed include waxes, basic nitrogen-containing polymers, copolymers containing amino groups and/or aminoalkyl groups, imino and/or pyridine groups.

Encapsulated active ingredients having a pH sensitive coating material to delay release of the actives, however, suffer a number of limitations, especially for fabric laundry applications. The use of pH sensitive materials alone to achieve triggered release of detergent actives to rinse cycle is difficult because of the problem of the active or beneficial agent prematurely leaking into the wash liquor during the washing cycle. As a consequence, all the detergent actives disperse in the washing liquor and are subsequently removed when the wash liquor drains between cycles, preventing the controlled release of the desired actives in post washing processes or the desired actives are released in amounts that are not effective in achieving the beneficial effect of the active as a result of controlled release. In addition, it is difficult to precisely control the release of active ingredients in a complex system such as a fabric laundry system including a broad spectrum of soil containing loads, numerous ingredients, varying water purity, varying amounts of water hardness, varying wash conditions, varying detergent concentration, a broad spectrum of washing machine designs, cycle lengths, washing and rinsing temperatures practiced by users worldwide. Despite attempts disclosed in the prior art to control the delivery of detergent active ingredients, numerous limitations associated with the controlled release materials has left many problems related to the controlled release of active ingredients and beneficial agents of utility in industrial applications, household products, and personal care largely unsolved. Inventors have discovered that polyelectrolyte compositions including one or more trigger means in addition to ionic strength have significant utility as triggered release barrier materials, encapsulating agents and devices for the triggered delivery of fabric care active ingredients and other related beneficial agents in an environment of use.

One practical solution to the problem of controlled release was to use polyelectrolyte compositions whose polymer properties such as stability and solubility were a function of changes in one or more chemical and/or physical properties of the aqueous system in which the polyelectrolyte was dispersed. Adjusting one or more chemical and/or physical properties of the aqueous system, such as the ionic strength, trigger the polyelectrolyte to respond by destabilizing, dissolving, swelling or dispersing in to the aqueous system under relatively low ionic strength conditions while remaining stable and insoluble in an altered or separate aqueous system under relatively high ionic strength conditions. Active ingredients and beneficial agents contained therein or encapsulated by barriers and devices constructed from such polyelectrolyte compositions are retained in order to protect such actives and agents in an aqueous system such as a fabric laundry wash cycle and which then can be triggered or manipulated to produce a desired release of actives via dissolution, degradation, swelling or dispersion of the polyelectrolyte barriers during a subsequent process, such as fabric laundry rinse cycle, the chemical/physical polymer response triggered through alterations of one or more or a series of chemical and/or physical properties of the aqueous system and one or more chemical and physical properties in addition to ionic strength including: pH, temperature, mechanical agitation and combinations of thereof.

The present inventors have discovered that alkali soluble/swellable polymers incorporating carefully selected monomer compositions and designed polymeric structures such that the response characteristics of the polymers is a function of changes in one or more chemical and physical properties of both the polyelectrolyte and the aqueous system in which they are in contact with (e.g. dispersed in) as a consequence of one or more parameters selected from: types and amounts of acidic monomers, degree of neutralization of the acidic monomers, types and amounts of non-ionic vinyl monomers, the ionic strength of the aqueous system, pH of the aqueous system, rates of polymer hydration, diffusion of water and ions within the polymer, polymer thermodynamic stability, polymer swelling rates and kinetics, and mechanical stability of polymer in the form of aggregated particles and films. Inventors have further discovered that such polyelectrolytes form effective barrier materials for surrounding one or more active ingredients in an aqueous system and that the stability of the barrier materials can be usefully manipulated to respond to changes in one or more chemical and/or physical properties of the aqueous system in addition to ionic strength including: base concentration, dilution with water, mechanical agitation, temperature and combinations thereof. In an aqueous system under relatively high ionic strength and alkaline conditions, the polymer compositions are sufficiently stable and form stable films. Exposing the compositions to an aqueous system under relatively lower ionic strength and alkaline conditions, triggers instability in the compositions such that the films are rapidly dispersed in the aqueous system. The triggered response compositions of the present invention obviate the limitations noted above and provide new compositions, films for making barriers, and processes for delivering controlled release of one or more active ingredients/beneficial agents to an environment of use.

Accordingly, there is provided a triggered response composition comprising: one or more polyelectrolytes in contact with an aqueous system that is stable and insoluble in an aqueous system at relatively high ionic strength and that exhibits one or more chemical/physical responses selected from dispersing, degrading, dissolving, deforming, destabilizing, swelling, softening, melting, flowing and combinations thereof; wherein the chemical/physical response of the composition is triggered upon one or more ionic strength changes, dilution or one or more changes in the concentration of base in the aqueous system. The polyelectrolyte is one or more alkali soluble/swellable emulsion polymers comprising: (a) 5-70 weight percent of one or more acidic monomers; (b) 30-95 weight percent of one or more non-ionic vinyl monomers; and optionally, (c) 0.001-5 weight percent of one or more polyethylenically unsaturated monomers or metal and/or alkaline earth cross-linking agents, wherein the chemical/physical response of the polymers as a function of ionic strength changes is dependent on one or more parameters selected from the group consisting of (i) the type and amounts of acidic monomers, (ii) the degree of neutralization of the acidic monomers, (iii) the type and amounts of non-ionic monomers, (iv) the type and amounts of polyethylenically unsaturated monomers or metal and/or alkaline earth cross-linking agents, (v) the pH of the aqueous system and (vi) combinations thereof. The composition is stable and insoluble in an aqueous system at relatively high ionic strength and the composition disperses, dissolves, deforms, swells or degrades in an aqueous system at relatively low ionic strength or when the ionic strength of the aqueous system in contact with the composition is lowered. The chemical/physical response of the polymers is a function of changes in one or more parameters of the aqueous system in addition to ionic strength or base concentration selected from: base concentration in the aqueous system, dilution of the aqueous system, surfactant concentration level, temperature, mechanical agitation and the combinations thereof. In a preferred embodiment, the polymer comprises: (a) 5-50 weight percent of one or more acidic monomers; (b) 45-95 weight percent of one or more non-ionic vinyl monomers; and optionally, (c) 0.01 to 5.0 weight percent of one or more metal cross-linking agents and alkaline earth cross-linking agents.

Secondly, there is provided a triggered response barrier composition comprising: one or more polyelectrolytes in contact with an aqueous system, wherein the barrier composition surrounds one or more active ingredients; wherein the barrier composition is stable and insoluble in an aqueous system at relatively high ionic strength or base strength; wherein the barrier exhibits one or more chemical/physical responses selected from dispersing, degrading, dissolving, destabilizing, deforming, swelling, softening, flowing and combinations thereof; wherein the chemical/physical response of the composition is triggered upon one or more ionic strength changes to the aqueous system, a lowering of the concentration of base in the aqueous system, or diluting the concentration of ions in the aqueous system; and wherein the barrier composition is capable of releasing the active ingredients to the aqueous system as a result of the triggered response.

There is also provided a process for triggering the release of one or more active ingredients to an aqueous system comprising the steps of:

(a) surrounding one or more active ingredients with an ionic strength responsive barrier composition, the barrier being substantially impermeable to releasing the active ingredients to the aqueous system and remaining insoluble in the aqueous system; and

(b) altering the ionic strength of the aqueous system, changing the base strength of the aqueous system, or diluting the aqueous system;

wherein the barrier composition disperses, destabilizes, disintegrates, dissolves, deforms, swells or combinations thereof and becomes substantially permeable, thereby releasing the active ingredients into the aqueous system.

The term “polyelectrolyte” as it relates to the present invention refers to a polymer or macromolecular compound in contact with an aqueous system containing a plurality of ionized and/or ionizable groups within the polymer as a result of the polymerization of one or more monomers having ionized and/or ionizable groups. The polyelectrolyte is in contact with an aqueous system including for example water, water incorporating hydrogen bonding solvents, polar solvents and organic solvents. It is contemplated that non-aqueous systems, including for example those containing solvents that can solvate ions and charged groups, are usefully employed in the present invention. Polyelectrolytes usefully employed in the invention may contain exclusively cationic groups, may contain exclusively anionic groups or may be amphoteric, containing a combination of cationic and anionic groups. The individual ionizable components of the polyelectrolyte include weak or strong acidic groups, such as for example sulphonic, phosphonic and carboxylic groups respectively; weak or strong basic groups such as for example primary amines, secondary amines, amides, phosphines and tertiary amines respectively; and amphoteric groups such as amino acids for example. The acidic groups of the polyelectrolytes are un-neutralized, partially neutralized or completely neutralized. The basic groups of the polyelectrolytes are un-neutralized and/or un-quaternized, partially neutralized and/or quaternized or completely neutralized and/or quaternized. Suitable examples of polyelectrolytes usefully employed in the invention include poly(acidic) homopolymers, copolymers and salts thereof such as polycarboxylic acid polymers and salts thereof, and biodegradable alkali soluble emulsion polymers such as polyaspartic acid and poly(D,L-lactic acid). Preferred polyelectrolyte include alkali soluble/swellable emulsion polymers, polyaspartic acid and Morez® polymers.

The term “triggered response” as it relates to the present invention refers to regulating, manipulating or altering one or more chemical/physical properties of a polymer composition in contact with an aqueous system by triggering changes in or through alteration of one or more chemical/physical parameters or properties of the aqueous system. Typical polymer chemical/physical parameters of interest include for example solubility, swelling behavior, stability, porosity, degree of neutralization, polymer colligative properties, acid/base properties of polymer functional groups, and reactivity of polymer functional groups. Typical chemical/physical parameters and properties of the aqueous system in addition to ionic strength include, for example, base concentration, dilution, temperature, mechanical forces such as pressure, osmotic pressure, diffusion, mechanical agitation, chemical reagents capable of reacting with or neutralizing polymer functional groups, colligative properties of the aqueous system and combinations of such parameters. The inventors have discovered that the solubility, dispersibility, deformability, swellability and stability response of alkali soluble/swellable emulsion (ASE) polymers in an aqueous system can be triggered by altering or changing the ionic strength of the aqueous system; and in addition to the ionic strength changes, changes in base concentration, dilution of the aqueous system, temperature, mechanical forces and combinations thereof.

Alkali soluble/swellable emulsion (ASE) polymers are polyelectrolytes based on acid-containing emulsion polymers disclosed in U.S. Pat. No. 3,035,004 and Great Britain Pat. No. 870,994. Alkali soluble resins (ASR) are polyelectrolytes based on acid-containing polymers and conventional methods used to prepare them are described in U.S. Pat. No. 5,830,957. ASR include polymers referred to as Morez® polymers. The inventors have discovered that adjusting the type and level of acid monomers and co-monomers in ASE and ASR polymers coupled with the degree of neutralization to achieve optimum charge density to afford polymers that are stable, having a low degree of swelling and insoluble in an aqueous system of relatively high ionic strength. The, polymers can be characterized as incorporating an ionic strength trigger or referred to as ionic strength, base strength or dilution responsive polymers. Changes in the ionic strength, base strength or dilution of the aqueous system to lower levels results in the a polymer that rapidly disperses, dissolves or swells to a significant extent in the aqueous system.

The alkali swellable/soluble polymers of the present invention are typically prepared using standard emulsion polymerization techniques under acidic conditions such that the carboxylic acid groups are in protonated form to insolubilize the polymer and afford a liquid emulsion. When added as a liquid colloidal dispersion, the finely divided polymer particles dissolve almost instantly upon pH adjustment. Alkali swellable/soluble resins are typically prepared by a heated and pressurized reactor (also referred to as a continuous tube reactor or Morez® reactor) and conventional methods used to prepare them are described in U.S. Pat. No. 5,830,957. ASR include polymers referred to as Morez® polymers. The degree of neutralization, the type and amounts of both acidic monomers and non-ionic surfactant groups of the polymers of both ASE polymers and ASR can be controlled precisely, affording ionic strength, base strength or dilution sensitive/responsive polymers whose stability, swell properties and solubility depend on the ionic strength, base strength or dilution of the aqueous system. The polymer compositions are also referred to as incorporating ionic strength, base strength and dilution triggering conditions. The ease of handling, metering, and dispersing the polymers, the rapid solubilization and optimization of charge density on neutralized acidic functional groups by controlled pH adjustment, and the highly desirable film forming and barrier properties make alkali soluble/swellable emulsion polymers and alkali soluble/swellable resins a most effective and efficient barrier composition for a wide variety of applications including regulated release devices for floor care and household actives. Both ASE polymers and ASR are usefully employed in the present invention for preparing, processing, and/or fabricating encapsulating compositions that include at least one active ingredient/beneficial agent; whereby the chemical/physical triggers included within the encapsulated composition and activated on contact with chemical/physical changes in an environment of use (e.g. an aqueous system) effect the controlled release of beneficial agents and active ingredients to the environment of use.

Required Monomer Components

The ASE polymers and ASR of this invention include the following monomer components: (a) 5-70 weight percent of one or more acidic monomers and (b) 30-95 weight percent of one or more non-ionic vinyl monomers. Optionally, the ASE polymers may include a third component (c) 0.01-5 weight percent of one or more metal cross-linking agents or one or more polyethylenically unsaturated monomers. It has been discovered that the effectiveness of the polymers as ionic strength, base strength or dilution responsive compositions for triggered release is critically dependent on the following components: (i) the type and amounts of acidic monomers, (ii) the degree of neutralization of the acidic monomers, and (iii) the type and amounts of non-ionic vinyl monomers, (iv) the type and amounts of polyethylenically unsaturated monomers or the type and amounts of metal cross-linking agents, (v) the pH of the aqueous system and (vi) combinations thereof.

Alkali swellable/soluble resins are typically prepared by a heated and pressurized reactor (also referred to as a continuous tube reactor or Morez® reactor) and conventional methods used to prepare them are described in U.S. Pat. No. 5,830,957. Final ASR physical characteristics are dependant upon monomer content, initiator type and quantity, reaction time and reaction temperature. ASR include polymers referred to as Morez® polymers. ASR have weight average molecular weights that range from 1,000 to 20,000. Polymer acid number can also be varied by depending upon the desired degree of water solubility or dispersibility. Resin acid numbers range from between 50 to 300. Aqueous solutions or dispersions of ASR may be prepared by simply mixing the resins with a solution of water and at least one base. The monomer feed to these reactors contains from 5 to 15% by weight solvent to control in-process viscosity. Typical solvents include but are not limited to alkylene glycols including dipropylene glycol monomethyl ether (DPM) and diethylene glycol monomethyl ether (DE). Some solvent becomes esterified in the ASR product and most of the residual solvent (@ 50% by weight) is removed by stripping. The level of incorporated solvent effects the performance of the dispersant as an aqueous emulsion or when employed as a stabilizer in an emulsion polymerization. The ASR are typically supplied as ammonia neutralized aqueous solutions, though they are also prepared as sodium hydroxide neutralized solutions as well. The resulting ASR dispersions can be formulated into dispersions or emulsions containing no volatile organic compounds (VOC). Both hydrophilic and hydrophobic ASR can be prepared. Hydrophobic monomers used to prepare hydrophobic or oil soluble ASR are described in U.S. Pat. Nos. 5,521,266 and 5,830,957. Hydrophobic monomers used to prepare hydrophobic or oil soluble ASR are described in U.S. Pat. No. 4,880,842.

Multistage ASR are also usefully employed in the present invention wherein a partially or fully neutralized ASR emulsion is used as a first stage (core stage) and a partially cross-linked to fully cross-linked ASR and/or an ASR having a substantially different Tg (typically but not exclusively higher than the core stage) is used as a second stage (shell stage). “Multiphase” polymer or resin refers to polymer particles with at least one inner phase or “core” phase and at least one outer phase or “shell” phase. The phases of the polymers are incompatible. Incompatible refers to the fact that the inner and the outer phases are distinguishable using analytical characterization techniques known to those having skill in the art. Typically, such techniques include but are not limited to electron microscopy and staining that differentiate or distinguish the phases. The morphological configuration of the phases of the polymers or resins may be for example core/shell; core/shell with shell particles partially encapsulating the core; core/shell particles with a multiplicity of cores; core/shell with a highly cross-linked shell; core/shell with a partially or highly degree of residual unsaturated groups or chemically reactive functional groups; or interpenetrating network particles. The preparation of multistage polymers is described in U.S. Pat. Nos. 3,827,996; 4,325,856; 4,654,397; 4,814,373; 4,916,171; 4,921,898; 5,521,266 and European Pat. No. EP 0 576 128 A1.

The acid monomers provide the requisite ionic strength and base strength responsiveness and the degree of neutralization of the acidic monomers is critical in optimizing the charge density of the acidic groups in both ASE polymers and ASR. The non-ionic vinyl monomers provide an extended polymer backbone structure and added hydrophobic balance. The non-ionic vinyl surfactant monomers provide a bound surfactant. All four components contribute to preparing ionic strength and base strength sensitive polymers and barrier compositions whose stability, swell properties and solubility depend on the ionic strength of the aqueous system. Within the stated limits, the proportions of the individual monomers can be varied to achieve optimum properties for specific triggered release applications.

Acidic Monomers

The ASE polymers and ASR require 5-70 weight percent based on total monomer content of one or more acidic monomers selected from the group consisting of C₃-C₈ α,β-ethylenically unsaturated carboxylic acid monomers such as acrylic acid, methacrylic acid, maleic acid, crotonic acid, itaconic acid, fumaric acid, aconitic acid vinyl sulfonic acids and vinyl phosphonic acids, acryloxypropionic acid, methacryloxypropionic acid, monomethyl maleate, monomethyl fumarate, monomethyl itaconate and the like, fatty acids such as lauroleic acid, myristoleic acid, palmitoleic acid, oleic acid, ricinoleic acid, linoleic acid, linolenic acid, eleostearic acid, laconic acid, gadoleic acid, arachidonic acid, erucic acid, clupanodonic acid and nisinic acid, and combinations thereof. Acrylic acid (AA), methacrylic acid (MAA) or mixtures thereof and oleic acid are preferred. Mixtures of AA or MAA with itaconic or fumaric acid are suitable and mixyures of crotonic and aconitic acid and half esters of these and other polycarboxylic acids such as maleic acid with C₁-C₄ alkanols are also suitable, particularly if used in minor amount in combination with acrylic or methacrylic acid. For most purposes, it is preferable to have at least about 15 weight percent and most preferably from about 5-50 weight percent of acidic monomers. However, polycarboxylic acid monomers and half esters can be substituted for a portion of the acrylic or methacrylic acid, e.g., about 1-15 weight percent based on total monomer content.

Non-Ionic Vinyl Monomers

To provide a stable aqueous dispersion and a desirable hydrophobic:hydrophilic balance needed for the ASE polymers and ASR of the present invention requires about 30-95 weight percent of one or more co-polymerizable non-ionic monomers selected from the group consisting of C₂-C₁₈ α,β-ethylenically unsaturated monomers, C₁-C₈ alkyl and C₂-C₈ hydroxy alkyl esters of acrylic and methacrylic acid including ethyl acrylate, ethyl methacrylate, methyl methacrylate, 2-ethylhexyl acrylate, butyl acrylate, butyl methacrylate, 2-hydroxyethyl acrylate, 2-hydroxybutyl methacrylate; styrene, alpha-methyl styrene, vinyltoluene, t-butylstyrene, isopropylstyrene, and p-chlorostyrene; vinyl acetate, vinyl butyrate, vinyl caprolate; acrylonitrile, methacrylonitrile, butadiene, isoprene, vinyl chloride, vinylidene chloride, and the like. In practice, a mono vinyl ester such as methyl acrylate, MMA, ethyl acrylate, butyl acrylate is preferred. In the case of ASR embodiments, mixtures of styrene and mono vinyl esters as well as mixtures of mono vinyl esters are preferred.

These monomers, of course, must be co-polymerizable with the acidic monomers. Normally about 30-95 weight percent, and preferably about 45-95 weight percent of nonionic vinyl monomer, based on total weight of monomers, is used in preparing the polymers.

It has been found that the balance of acidic monomers to non-ionic monomers is an important factor in the triggered release response and performance of the resulting polymers used in barrier or compositions. It is contemplated that the polymers of the present invention have encapsulating properties in addition to having utility as barrier compositions.

In one embodiment, the composition is a polyelectrolyte of 52.5 weight percent methyl methacrylate (MMA), 29.5 weight percent butyl acrylate (BA), 18 weight percent methacrylic acid (MAA) and 1.5 weight percent 3-mercaptopropionic acid (3-MPA). The polyelectrolyte is stable in an aqueous solution of NaOH of 2.5 M or greater and is triggered to swell/dissolve/disperse by lowering the concentration of NaOH to 1.0 M or less.

In a separate embodiment, the composition is a polyelectrolyte of 33 weight percent styrene (Sty), 35 weight percent butyl acrylate (BA), 7 weight percent methyl methacrylate (MMA) and 25 weight percent methacrylic acid (MAA). The polyelectrolyte is stable in an aqueous solution of NaOH of 1.0 M or greater and is triggered to swell/dissolve/disperse by lowering the concentration of NaOH to 0.1 M or less.

In another separate embodiment, there is provided a triggered response composition comprising: one or more polyelectrolytes in contact with an aqueous system that is stable and insoluble in an aqueous system at relatively high ionic strength and that exhibits one or more chemical/physical responses selected from dispersing, degrading, dissolving, destabilizing, deforming, swelling, softening, melting, spreading, flowing and combinations thereof; wherein the chemical/physical response of the composition is triggered upon one or more ionic strength changes, dilution or one or more changes in the concentration of base in the aqueous system. The polyelectrolyte is one or more Morez® polymers comprising: (a) 5-70 weight percent of one or more acidic monomers; (b) 15-95 weight percent of one or more non-ionic vinyl monomers; and optionally (c) 0.01-5 weight percent of one or more polyethylenically unsaturated monomers or cross-linking. Suitable Morez® polymers and conventional methods used to prepare them are described in U.S. Pat. No. 5,830,957.

Optionally, the polymers include a small amount of at least one polyethylenically unsaturated monomer, to provide a polymer having a network structure. One or more polyethylenically unsaturated monomers may be combined with the monomers during the polymerization process or may be added after the polymerization of monomers. Suitable examples include allyl methacrylate (ALMA), ethylene glycol dimethacrylate (EGDMA), butylene glycol dimethacrylate (BGDMA), diallyl pentaerythritol (DAP), methylenebisacrylamide, pentaerythritol di-, tri- and tetra-acrylates, divinyl benzene, polyethylene glycol diacrylates, bisphenol A diacrylates and combinations thereof. Low levels of the polyethylenically unsaturated monomers are preferred, since levels greater than about 5% by weight tend to over cross-link the polymer or provide a polymer network structure such that their effectiveness in the invention markedly decreases. Preferred amounts of the polyethylenically unsaturated monomers range from 0.001 to 5% by weight based on the total weight of the polymer, more preferably from 0.05 to 1.0% by weight based on the total weight of the polymer.

Another optional monomer component of includes a small amount of at least one metal and/or alkaline earth cross-linking agent, to provide a polymer having a more rigid structure and better mechanical properties. One or more metal and/or alkaline earth cross-linking agents may be combined with the monomers during the polymerization process or may be added after the polymerization of monomers. Suitable metal and/or alkaline earth cross-linking agents include for example alkaline earth ions of calcium, magnesium and barium, transition metal ions of iron, copper and zinc. Other suitable examples such as aluminum ions are described in U.S. Pat. No. 5,319,018. Preferred amounts of the metal and/or alkaline earth cross-linking agents range from 0.01 to 5% by weight based on the total weight of the polymer, more preferably from 0.05 to 5% by weight based on the total weight of the polymer.

Polymerization Conditions

The ASE polymers are conveniently prepared from the above-described monomers by conventional emulsion polymerization at an acid pH lower than about 5.0 using free-radical producing initiators, usually in an amount from 0.01 percent to 3 percent based on the weight of the monomers. Alkali swellable/soluble resins are typically prepared by a heated and pressurized reactor (also referred to as a continuous flow tube reactor or Morez® reactor) at temperatures typically less than 300° C and typically less than 200 psi ( kPa) and conventional methods used to prepare them are described in U.S. Pat. No. 5,830,957. Final ASR physical characteristics are dependant upon monomer content, initiator type and quantity, reaction time and reaction temperature.

Free-radical producing initiators conveniently employed for preparing both ASE polymers and ASR are peroxygen compounds especially inorganic persulfate compounds such as ammonium persulfate, potassium persulfate, sodium persulfate; peroxides such as hydrogen peroxide; organic hydroperoxides, for example, cumene hydroperoxide, t-butyl hydroperoxide; organic peroxides, for example, benzoyl peroxide, acetyl peroxide, lauroyl peroxide, peracetic acid, and perbenzoic acid (sometimes activated by a water-soluble reducing agent such as ferrous compound or sodium bisulfite); as well as other free-radical producing materials such as 2,2′-azobisisobutyronitrile.

The process for preparing polymers of this invention includes a free radical thermal initiator or redox initiator system under emulsion polymerization conditions. Monomers suitable for the novel process include hydrophobic and hydrophilic monoethylenically unsaturated monomers which can be subjected to free radical polymerization in a straight forward manner. “Hydrophilic” refers to monoethylenically unsaturated monomers which have high water solubility under the conditions of emulsion polymerization, as described in U.S. Pat. No. 4,880,842.

Suitable thermal initiators include, for example, hydrogen peroxide, peroxy acid salts, peroxodisulfuric acid and its salts, peroxy ester salts, ammonium and alkali metal peroxide salts, perborate salts and persulfate salts, dibenzoyl peroxide, t-butyl peroxide, lauryl peroxide, 2, 2′-azo bis(isobutyronitrile) (AIBN), alkyl hydroperoxides such as tert-butyl hydroperoxide, tert-amyl hydroperoxide, pinene hydroperoxide and cumyl hydroperoxide, t-butyl peroxyneodecanoate, t-butyl Peroxypivalate and combinations thereof.

Suitable oxidants of the redox initiator system include water-soluble oxidizing compounds such as, for example, hydrogen peroxide, peroxy acid salts, peroxodisulfuric acid and its salts, peroxy ester salts, ammonium and alkali metal peroxide salts, perborate salts and persulfate salts. Suitable oxidants of a redox initiator system also include water-insoluble oxidizing compounds such as, for example, dibenzoyl peroxide, t-butyl peroxide, lauryl peroxide, 2, 2′-azo bis(isobutyronitrile) (AIBN), alkyl hydroperoxides such as tert-butyl hydroperoxide, tert-amyl hydroperoxide, pinene hydroperoxide and cumyl hydroperoxide, t-butyl peroxyneodecanoate, and t-butyl peroxypivalate. Compounds which donate oxygen with free radical formation and are not peroxides, such as alkali metal chlorates and perchlorates, transition metal oxide compounds such as potassium permanganate, managanese dioxide and lead oxide and organic compounds such as iodobenzene, may be usefully employed in accordance with the invention as oxidants. The term “water-insoluble” oxidants means oxidizing compounds having a water solubility of less than 20% by weight in water at 25° C. Peroxides, hydroperoxides and mixtures thereof are preferred and tert-butyl hydroperoxide is most preferred. Typical levels of oxidant range from 0.01% to 3.0%, preferably from 0.02% to 1.0% and more preferably from 0.05% to 0.5% by weight, based on the weight of the monomer used.

Suitable reductants of the redox initiator system include reducing compounds such as, for example, sulfur compounds with a low oxidation state such as sulfites, hydrogen sulfites, alkali metal bisulfites, ketone adducts of bisulfites such as acetone bisulfite, alkali metal disulfites, metabisulfites and its salts, thiosulfates, formaldehyde sulfoxylates and its salts, reducing nitrogen compounds such as hydroxylamine, hydroxylamine hydrosulfate and hydroxylammonium salts, polyamines and reducing sugars such as sorbose, fructose, glucose, lactose and derivatives thereof, enediols such as ascorbic acid and isoascorbic acid, sulfinic acids, hydroxy alkyl sulfinic acids such as hydroxy methyl sulfinic acid and 2-hydroxy-2-sulfinacetic acid and its salts, formadinesulfinic acid and its salts, alkyl sulfinic acids such propyl sulfinic acid and isopropyl sulfinic acid, aryl sulfinic acids such as phenyl sulfinic acid. The term “salts” includes for example sodium, potassium, ammonium and zinc ions. Sodium formaldehyde sulfoxylate, also known as SSF, is preferred. Typical levels of reductant range from 0.01% to 3.0%, preferably from 0.01% to 0.5% and more preferably from 0.025% to 0.25% by weight, based on the weight of the monomer used.

The metal promoter complex of the redox initiator system includes a water-soluble catalytic metal compound in the form of a salt and a chelating ligand. Suitable metal compounds include metal salts such as, for example iron(II, III) salts such as iron sulfate, iron nitrate, iron acetate and iron chloride, cobalt(II) salts, copper(I, II) salts, chromium (II) salts, manganese salts, nickel(II) salts, vanadium salts such as vanadium(III) chloride, vanadium(IV) sulfate and vanadium(V) chloride, molybdenum salts, rhodium salts and cerium(IV) salts. It is preferred that metal compounds are in the form of hydrated metal salts. Typical levels of catalytic metal salts used in accordance with the invention range from 0.01 ppm to 25 ppm. Mixtures of two or more catalytic metal salts may also be usefully employed in accordance with the invention.

Metal complexes that promote the redox cycle in a redox initiator system must not only be soluble, but must have suitable oxidation and reduction potentials. Generally stated, the oxidant must be able to oxidize the low oxidation state of metal promoter complex (e.g. Fe(II)→Fe(III)) and conversely, the reductant must be able to reduce the high oxidation state of the metal promoter catalyst (e.g. Fe(III)→Fe(II)). The choice of a particular oxidant and reductant usefully employed in a redox initiator system for preparing aqueous emulsion polymers from two or more ethylenically unsaturated monomers depends on the redox potentials of the metal salts. In addition, the ratio of oxidant to reductant ranges from 0.1:1.0 to 1.0:0.1, depending on the redox potential of the metal salt employed. For the efficient reduction of monomer levels in an aqueous polymer dispersion prepared from one or more ethylenically unsaturated monomers, it is preferred that the chelating ligand used in combination with the soluble metal salt is a multidentate aminocarboxylate ligand having fewer than six groups available for coordination to the metal salt.

Oxidant and reductant are typically added to the reaction mixture in separate streams or as a single shot, preferably concurrently with the monomer mixture. The reaction temperature is maintained at a temperature lower than 100° C. throughout the course of the reaction. Preferred is a reaction temperature between 30° C. and 85° C., preferably below 60° C. The monomer mixture may be added neat or as an emulsion in water. The monomer mixture may be added in one or more additions or continuously, linearly or not, over the reaction period, or combinations thereof. The type and amount of redox initiator systems may be the same or different in the various stages of the emulsion polymerization.

Optionally, a chain transfer agent and an additional emulsifier can be used. Representative chain transfer agents are carbon tetrachloride, bromoform, bromotrichloromethane, long chain alkyl mercaptans and thioesters such as n-dodecyl mercaptan, t-dodecyl mercaptan, octyl mercaptan, tetradecyl mercaptan, hexadecyl mercaptan, butyl thioglycolate, isooctyl thioglycolate, and dodecyl thioglycolate. The chain transfer agents are used in amounts up to about 10 parts per 100 parts of polymerizable monomers.

Often at least one anionic emulsifier is included in the polymerization charge and one or more of the known nonionic emulsifiers may also be present. Examples of anionic emulsifiers are the alkali metal alkyl aryl sulfonates, the alkali metal alkyl sulfates and the sulfonated alkyl esters. Specific examples of these well-known emulsifiers are sodium dodecylbenzenesulfonate, sodium disecondary-butylnaphthalene sulfonate, sodium lauryl sulfate, disodium dodecyldiphenyl ether disulfonate, disodium n-octadecylsulfosuccinamate and sodium dioctylsulfosuccinate.

Optionally, other ingredients well known in the emulsion polymerization art may be included such as chelating agents, buffering agents, inorganic salts and pH adjusting agents.

Polymerization at an acid pH lower than about 5.0 permits direct preparation of an aqueous colloidal dispersion with relatively high solids content without problems of undue viscosity and coagulant formation. The polymerization is carried out batch-wise, stepwise or continuously with batch and/or continuous addition of the monomers in a conventional manner.

The required monomers can be co-polymerized in such proportions, and the resulting emulsion polymers can be physically blended, to give products with the desired balance of properties for specific applications. Thus, by varying the monomers and their proportions, emulsion polymers having optimum properties for particular triggered response applications can be designed.

In practice it is normally desirable to co-polymerize about 5-70 weight percent based on total monomers, preferably about 5-50 weight percent of one or more acidic monomers, about 30-95 weight percent, preferably about 45-95 weight percent, of one or more non-ionic vinyl monomers.

Polymer Properties

In general, the ASE copolymer dispersions obtained have a solids content ranging from 20 to 50% by weight and the ASE copolymer has a weight average molecular weight of about 200,000 to 10,000,000, when no polyethylenically unsaturated monomer or metal cross-linking agent is incorporated in to the polymer, as determined by gel permeation chromatography (GPC). A chain transfer agent may be used to obtain weight average molecular weights down to 30,000 or lower. The ASR aqueous dispersions obtained have a solids content ranging from 10 to 50% by weight and the ASR has a weight average molecular weight of from 1,000 to 20,000 when no polyethylenically unsaturated monomer or metal cross-linking agent is incorporated in to the polymer, as determined by gel permeation chromatography (GPC). Typical pH of ASR aqueous ammonia dispersions are between 7.0 to 9.0. ASR dispersion at an acidic pH are in the form of stable colloidal dispersions with a typical opaque appearance. Typical viscosities of ASR range between 300 and 2500 cps and have been 25 to 35% by weight non-volatiles. The Morez® polymers typically are prepared in the form of resins or a prepared as ammonia neutralized aqueous solutions. Such a liquid dispersion contains the copolymer dispersed as discrete particles having average particle diameters of about 5-3000 Å, as measured by light scattering. Particle size can range between 0.5 nm to 3000 μm depending on polymerization conditions and processes employed.

The ASE copolymer products prepared by emulsion polymerization at an acid pH are in the form of stable aqueous colloidal dispersions usually with a typical milky latex appearance. Such a liquid emulsion contains the copolymer dispersed as discrete particles having average particle diameters of about 500-3000 Å, as measured by light scattering. Particle size can range between 5 nm to 3000 μm depending on polymerization conditions and processes employed.

In the form of a stable, aqueous colloidal dispersion at an acid pH of about 2.5-5.0 both the ASE copolymers and ASR are particularly useful in preparing barrier materials and have desirable film forming properties. Such aqueous dispersion contain about 10-50 weight percent of polymer solids yet are of relatively low viscosity. Thus it is readily metered and blended with aqueous product systems. However, the dispersion is responsive to changes in base strength, pH, ionic strength and/or to dilution of the aqueous system. When the ionic strength and/or pH of the polymer dispersion is adjusted by addition of a base such as ammonia, an amine or a non-volatile inorganic base such as sodium hydroxide, potassium carbonate or the like, the aqueous mixture becomes translucent or transparent as the polymer dissolves at least partially in the aqueous phase with a concurrent increase in viscosity. This neutralization can occur in-situ when the liquid emulsion polymer is blended with an aqueous solution containing a suitable base. Or if desired for a given application, pH adjustment by partial or complete neutralization or no pH adjustment can be carried out before or after blending the liquid emulsion polymer with an aqueous product.

The glass transition temperature (“Tg”) of the ASE polymers typically range from −60° C. to 150° C., preferably from −20 C to 50° C., the monomers and amounts of the monomers selected to achieve the desired polymer Tg range are well known in the art. The glass transition temperature (“Tg”) of the ASR typically range from 0° C. to 150° C., preferably from 50 C. to 100° C., the monomers and amounts of the monomers selected to achieve the desired polymer Tg range are well known in the art. Tgs used herein are those calculated by using the Fox equation (T. G. Fox, Bull. Am. Physics Soc., Volume 1, Issue No. 3, page 123(1956)). that is, for calculating the Tg of a copolymer of monomers M1 and M2,

1/Tg(calc.)=w(M1)/Tg(M1)+w(M2)/Tg(M2), wherein

Tg(calc.) is the glass transition temperature calculated for the copolymer

w(M1) is the weight fraction of monomer M1 in the copolymer

w(M2) is the weight fraction of monomer M2 in the copolymer

Tg(M1) is the glass transition temperature of the homopolymer of M1

Tg(M2) is the glass transition temperature of the homopolymer of M2,

All temperatures being in °K. The glass transition temperatures of homopolymers may be found, for example, in “Polymer Handbook”, edited by J. Brandrup and E. H. Immergut, Interscience Publishers.

The polymers of this invention are advantageous for use as barrier compositions that surround one or more active ingredients/beneficial agents. Two or more polymers may be used, if desired. Of course the polymers are preferably film-forming at temperatures below about 25° C., either inherently or through the use of plasticizers. The polymers form effective barrier materials for surrounding and/or encapsulating one or more active ingredients immersed in an aqueous system, such that the stability of the barrier materials changes in addition to ionic strength and base strength by changing base concentration, salt concentration, ionic strength, pH, dilution, temperature, mechanical forces and the combinations thereof within the aqueous system. In an aqueous system the materials are stable, forming effective barriers to contain or encapsulate one or more actives. Exposing the materials to subsequent changes in chemical/physical conditions within the aqueous system triggers instability in the materials such that the active ingredients are rapidly dispersed in the aqueous system.

Typically, a barrier composite is composed of the triggered response polymers and polymers, biopolymers, and any other naturally occurring and synthetic material, although appropriately treated inorganic materials such as ceramics, metals or glasses may be used. The following is a preferred listing of components and additives that can be incorporated into the barrier material and device of the present invention.

Cellulose esters such as cellulose acetate, cellulose acetate acetoacetate, cellulose acetate benzoate, cellulose acetate butylsulfonate, cellulose acetate butyrate, cellulose acetate butyrate sulfate, cellulose acetate butyrate valerate, cellulose acetate caprate, cellulose acetate caproate, cellulose acetate caprylate, cellulose acetate carboxymethoxypropionate, cellulose acetate chloroacetate, cellulose acetate dimethaminoacetate, cellulose acetate dimethylaminoacetate, cellulose acetate dimethylsulfamate, cellulose acetate dipalmitate, cellulose acetate dipropylsulfamate, cellulose acetate ethoxyacetate, cellulose acetate ethyl carbamate, cellulose acetate ethyl carbonate, cellulose acetate ethyl oxalate, cellulose acetate furoate, cellulose acetate heptanoate, cellulose acetate heptylate, cellulose acetate isobutyrate, cellulose acetate laurate, cellulose acetate methacrylate, cellulose acetate methoxyacetate, cellulose acetate methylcarbamate, cellulose acetate methylsulfonate, cellulose acetate myristate, cellulose acetate octanoate, cellulose acetate palmitate, cellulose acetate phthalate, cellulose acetate propionate, cellulose acetate propionate sulfate, cellulose acetate propionate valerate, cellulose acetate p-toluene sulfonate, cellulose acetate succinate, cellulose acetate sulfate, cellulose acetate trimellitate, cellulose acetate tripropionate, cellulose acetate valerate, cellulose benzoate, cellulose butyrate napthylate, cellulose butyrate, cellulose chlorobenzoate, cellulose cyanoacetates, cellulose dicaprylate, cellulose dioctanoate, cellulose dipentanate, cellulose dipentanlate, cellulose formate, cellulose methacrylates, cellulose methoxybenzoate, cellulose nitrate, cellulose nitrobenzoate, cellulose phosphate (sodium salt), cellulose phosphinates, cellulose phosphites, cellulose phosphonates, cellulose propionate, cellulose propionate crotonate, cellulose propionate isobutyrate, cellulose propionate succinate, cellulose stearate, cellulose sulfate (sodium salt), cellulose triacetate, cellulose tricaprylate, cellulose triformate, cellulose triheptanoate, cellulose triheptylate, cellulose trilaurate, cellulose trimyristate, cellulose trinitrate, cellulose trioctanoate, cellulose tripalmitate, cellulose tripropionate, cellulose trisuccinate, cellulose trivalerate, cellulose valerate palmitate and combinations thereof. Cellulose ethers such as 2-hydroxybutyl methyl cellulose, 2-hydroxyethyl cellulose, 2-hydroxyethyl ethyl cellulose, 2-hydroxyethyl methyl cellulose, 2-hydroxypropyl cellulose, 2-hydroxypropyl methyl cellulose, dimethoxyethyl cellulose acetate, ethyl 2-hydroxylethyl cellulose, ethyl cellulose, ethyl cellulose sulfate, ethylcellulose dimethylsulfamate, methyl cellulose, methyl cellulose acetate, methylcyanoethyl cellulose, sodium carboxymethyl 2-hydroxyethyl cellulose, sodium carboxymethyl cellulose. Polycarbonates. Polyurethanes. Polyvinyl acetates. Polyvinyl alcohols. Polyesters. Polysiloxanes such as poly(dimethylsiloxane) and Polyaminoacids such as polyaspartic acid. Polyacrylic acid derivatives such as polyacrylates, polymethyl methacrylate, poly(acrylic acid) higher alkyl esters, poly(ethylmethacrylate), poly(hexadecyl methacrylate-co-methylmethacrylate), poly(methylacrylate-co-styrene), poly(n-butyl methacrylate), poly(n-butyl-acrylate), poly(cyclododecyl acrylate), poly(benzyl acrylate), poly(butylacrylate), poly(secbutylacrylate), poly(hexyl acrylate), poly(octyl acrylate), poly(decyl acrylate), poly(dodecyl acrylate), poly(2-methyl butyl acrylate), poly(adamantyl methacrylate), poly(benzyl methacrylate), poly(butyl methacrylate), poly(2-ethylhexyl methacrylate), poly(octyl methacrylate), acrylic resins. Polyethers such as poly(octyloxyethylene), poly(oxyphenylethylene), poly(oxypropylene), poly(pentyloxyethylene), poly(phenoxy styrene), poly(secbutroxylethylene), poly(tert-butoxyethylene), copolymers thereof and polymer blends thereof.

Typical naturally occurring materials include: insect and animal waxes such as chinese insect wax, beeswax, spermaceti, fats and wool wax; vegetable waxes such as bamboo leaf wax, candelilla wax, carnauba wax, Japan wax, ouricury wax, Jojoba wax, bayberry wax, Douglas-Fir wax, cotton wax, cranberry wax, cape berry wax, rice-bran wax, castor wax, indian corn wax, hydrogenated vegetable oils (e.g., castor, palm, cottonseed, soybean), sorghum grain wax, Spanish moss wax, sugarcane wax, caranda wax, bleached wax, Esparto wax, flax wax, Madagascar wax, orange peel wax, shellac wax, sisal hemp wax and rice wax; mineral waxes such as Montan wax, peat waxes, petroleum wax, petroleum ceresin, ozokerite wax, microcrystalline wax and paraffins; and synthetic waxes such as polyethylene wax, Fischer-Tropsch wax, chemically modified hydrocarbon waxes including polyethyleneglycolated waxes and cetyl esters wax.

In one embodiment, the ionic strength trigger is an ionic strength sensitive barrier composition surrounding the ingredients, the barrier substantially impermeable to releasing the active ingredients to the aqueous system and remaining insoluble in the aqueous system at relatively high ionic strength (for example, equivalent to 0.5 M sodium chloride or greater), the barrier becoming soluble in an aqueous system at relatively lower ionic strength (for example, equivalent to less than 0.5 M sodium chloride) and effecting the rapid release of the active ingredients.

In a separate embodiment, the ionic strength trigger is a base strength sensitive barrier composition surrounding the ingredients, the barrier substantially impermeable to releasing the active ingredients to the aqueous system and remaining insoluble in the aqueous system at relatively high base strength ( for example, equivalent to 2.5 M sodium hydroxide or greater), the barrier becoming soluble in an aqueous system at relatively lower base strength (for example, equivalent to less than 1.0 M sodium hydroxide) and effecting the rapid release of the active ingredients.

In another separate embodiment, the ionic strength trigger is a base strength dilution sensitive barrier composition surrounding the ingredients, the barrier substantially impermeable to releasing the active ingredients to the aqueous system and remaining insoluble in the aqueous system at relatively high concentrations of ions (for example, equivalent to 2.5 M sodium hydroxide or greater), the barrier becoming soluble in an aqueous system at a 20:1 (vol:vol) dilution using water including negligible amounts of ions or none (de-ionized water), for example, and effecting the rapid release of the active ingredients.

Optionally, the triggered responsive barrier materials comprise a plurality of trigger response polymer blends or they are blended with an inert non-dissolving material. By inert is meant a material that is not substantially affected by a change in ionic strength and/or pH in the triggering range. By altering the proportion of a ionic strength and pH-responsive material to one or more inert non-dissolving materials, the time lag subsequent to triggering and prior to release may be controlled. The inert non-dissolving material is added to further provide mechanical strength and stability to the barrier material or device during use (for example, after the polymer and barrier swells) or storage. Typical inert non-dissolving material usefully employed in the invention is listed the materials described as additives to the barrier material or device. Preferably, the inert material is selected from the list of additives given above.

The term beneficial agent refers to substances for which it is desirable and/or advantageous to triggered delivery into an environment of use. Beneficial agents include those agents in the form of a gas, solid or liquid state.

The term beneficial agent refers to substances for which it is desirable and/or advantageous to control delivery into an environment of use. Examples of such substances include: detergent additives and cleaning additives including, for example, fabric softeners, fabric softener formulations, cationic and anionic surfactants, scale controllers, buffers, amphoteric additives, builders, bleaches, organic additives, inorganic additives, whiteners, dyestuffs, stain removers, water hardness agents, reductants, oxidants, optical brighteners, UV protective agents, wrinkle reducing agents, gray-inhibitors, anti-foaming agents, soil repellants, oil-absorbing polymers, waterproofing polymers, active-retaining polymers, redeposition agents, anti-redeposition agents, polymers which inhibit the formation of soil and oily materials, detergent additive formulations, biocidal compositions and formulations, antimicrobial compositions and formulations, activating agents, stabilizing agents, polymers with special detergent properties such as co-builders and anti-redeposition agents, pH controlling agents, enzymes, enzyme inhibitors, disinfectants, personal care agents, water softening agents, absorbants, flavors and fragrances.

Although any mixture of the above ingredients may be used that satisfactorily delivers the beneficial agent, typically the triggered response barrier material is 0.01% to 30% by weight of a device and the barrier including trigger means is typically 1% to 30% of the device.

In a conventional fashion, the triggered response polymers may be molded into the desired shapes and sintered or dip-coated (in a similar fashion to the way hard gelatin capsules are made). Preferably they are by conventional coating techniques including, for example, spray coating, Wurster coating, coacervation, spray drying, interfacial deposition techniques, in-liquid drying processes, non-solvent addition, droplet extrusion, reconstitution, wet milling, agglomerization, fluid bed spraying, fluid bed granulation, particle atomization, aerosol deposition, micro-droplet extrusion, nano-droplet extrusion, and pan coating. Alternatively, hard gelatin capsules may be coated with the barrier coating. This may be performed using conventional methods and equipment.

It is contemplated that barrier compositions prepared from one or more the ASE polymers or the ASR form impermeable barriers that surround or encapsulate one or more active ingredients, providing sufficient structural support while inhibiting the release of the beneficial agent prior to the triggered dissolution or dispersion of the barriers of the device. Aqueous system refers to but not limited to a solution containing water as the principal liquid component (e.g., solutions of organic or inorganic substances particularly electrolytes and surfactant mixtures of substance in water). Typically the barrier composition totally surrounds the beneficial agent/active ingredient or forms an impermeable matrix of the barrier composition and the beneficial agent/active ingredient. The impermeable barrier membrane material has a combination of thickness and mechanical strength so that it will be sufficiently stable at predetermined system including but not limited to a heavy duty liquid (HDL) formulation or fabric laundry wash cycle and will rapidly disrupt and release the beneficial ingredients once the desired triggered release environment has been generated. Preferably the impermeable barrier membrane is 5 μm to 300 μm in thickness for household and personal care applications, such as fabric care laundry application. The impermeable barrier membrane may be a dense film, a composite membrane, asymmetric in structure, etc. The preferred particle size of the impermeable matrix beads of the barrier composition and the beneficial agent/active ingredient is from 2 to 5000 μm. Typically the device of the barrier composition material and the beneficial ingredients is composed of emulsion polymers and personal care and household care actives including but not limited to fabric care actives.

It is contemplated that the selected group of polymers in any structural form may be used as the ionic strength, pH, base concentration level, dilution, temperature, mechanical force and the combinations of thereof trigger means that maintains the integrity of the device until triggered by a solution of the desired conditions. The trigger device may be for example an impermeable dense coating membrane or an impermeable matrix. Preferably, the trigger device provides sufficient structural support and is impermeable to water which inhibits the core from contacting with the aqueous system, and releasing the beneficial agent until triggered. Typically the trigger device is selected from a group of polymeric barrier compositions surrounding the ingredients, the barrier substantially impermeable to releasing the active ingredients to the aqueous system and remaining insoluble in the aqueous system at a predetermined conditions, the barrier becoming soluble or dispersible or disintegrates in an aqueous system when the ionic strength, pH, base concentration, dilution, temperature, surfactant concentration level of the aqueous system, mechanical force and the combinations of thereof changed, effecting the rapid release of the active ingredients.

Typically the barrier materials are insoluble solids in an aqueous system including but not limited to fabric laundry wash cycle, and then they dissolve (or degrade and dissolve) when the ionic strength, pH, surfactant concentration level, temperature, mechanical force and the combinations of thereof changed in the system.

The devices of this invention having the above described desired characteristics may be made using the above described materials using the following processes and other conventional techniques and methods. Conventional techniques for preparing delivery devices include, for example, those disclosed in U.S. Pat. No. 5,358,502.

It should be understood that the invention is not limited to the particular embodiments shown and described herein, but that various changes and modifications may be made without departing from the spirit and scope hereof as defined by the following claims. The invention is further illustrated and defined in the following examples.

Preparation of Triggered Response Compositions

The polymer emulsions of interest are diluted to 20 weight percent polymers solids and completely neutralized by raising the pH of the aqueous emulsion to 10 with an aqueous solution of sodium hydroxide (2%). To the emulsions are added 100 ppm of FC-120 wetting aid and, if required, 10 -20% of a coalescing agent on the polymer solids. The coalescing agent used typically is Dowanol® DE (diethylene glycol mono methyl ether). Some of the emulsion is cast on a glass plate and allowed to dry. The dried film is cut in to test strips. To run cubic swell ratios during the testing, the strips are cut 2 centimeters in length.

Film strips are tested for a triggered response to ionic strength and base strength concentration changes in 1.2% Bold® detergent solution and 0.6% Tide® detergent solution in vials in a water bath held at 60° C. for at least 30 minutes. If the film is still intact after that time, 95% of the detergent solution in the vial is removed and replaced with tap water in order to assess how the film responds in water of neutral pH and relatively low ionic strength. Cubic swell ratios are measured after testing and are equal to the cubic ratio of the film length exposed to ions and bases to the original film length as cast, [final length/original length]³.

### EXAMPLE 1

The composition is a polyelectrolyte of 52.5 weight percent methyl methacrylate (MMA), 29.5 weight percent butyl acrylate (BA), 18 weight percent methacrylic acid (MAA) and 1.5 weight percent 3-mercaptopropionic acid (3-MPA). The polyelectrolyte is stable in an aqueous solution of NaOH of 2.5 M or greater and is triggered to swell/dissolve/disperse by lowering the concentration of NaOH to 1.0 M or less.

### EXAMPLE 2

In another preferred embodiment, the composition is a polyelectrolyte of 33 weight percent styrene (Sty), 35 weight percent butyl acrylate (BA), 7 weight percent methyl methacrylate (MMA) and 25 weight percent methacrylic acid (MAA). The polyelectrolyte is stable in an aqueous solution of NaOH of 1.0 M or greater and is triggered to swell/dissolve/disperse by lowering the concentration of NaOH to 0.1 M or less.

### EXAMPLE 3

An aqueous solution of composition 60 BA/21MMA/10 2-ethyl hexyl acrylate (HEMA)/9MAA (1% backbone cross-linking with zinc ions), was adjusted to pH 10.5 using aqueous 2% NaOH solution. Film fell apart at 60° C. in 1.2% Bold in 4 min. and disintegrated in 8 min. Film was close to degrading at 60° C. in 0.6% Tide after 30 min. Fell apart upon 20:1 dilution (vol:vol) yet did not dissolve or disintegrate. Film fell apart at 60° C. in 0.6% Bold in 20 min. and disintegrated in 30 min.

### EXAMPLE 4

An aqueous solution of composition 60 BA/21MMA/10 HEMA/9MAA (1% backbone cross-linking with calcium ions), was adjusted to pH 11.0 using aqueous 2% NaOH solution. Film was delicate/fragile at 60° C. in 1.2% Bold after 20 min. and disintegrated in 30 min. Film was delicate/fragile at 60° C. in 0.6% Tide after 35 min. Fell apart upon 20:1 dilution (vol:vol) yet did not dissolve or disintegrate.

### EXAMPLE 5

An aqueous solution of composition 60 BA/21MMA/10 HEMA/9MAA (1% backbone cross-linking with magnesium ions), was adjusted to pH 10.5 using aqueous 2% NaOH solution. Film disintegrated at 60° C. in 1.2% Bold after 30 min. Film was swollen but still remained intact at 60° C. in 0.6% Tide after 35 min. Fell apart upon 20:1 dilution (vol:vol).

### EXAMPLE 6

An aqueous solution of composition containing 65 weight percent of 60 BA/21MMA/10 HEMA/9MAA and 35 weight percent of 80 Sty/10MMA/10AA (1% backbone cross-linking with zinc ions), was adjusted to pH 10.5 using aqueous 2% NaOH solution. Film fell apart at 60° C. in 1.2% Bold after 20 min. and disintegrated in 35 min. Film was swollen but remained intact 60° C. in 0.6% Tide after 35 min. Mild agitation caused upon 20:1 dilution (vol:vol) caused the film to break into 20 pieces. No dissolution or disintegration.

### EXAMPLE 7

An aqueous solution of composition containing 65 weight percent of 60 BA/21MMA/10 HEMA/9MAA and 35 weight percent of 80 Sty/10MMA/10AA (1% backbone cross-linking with calcium ions), was adjusted to pH 11.0 using aqueous 2% NaOH solution. Film swelled upon 20:1 dilution (vol:vol) yet retained integrity. Cubic swell ratio (CSR) in 0.6% Tide wash, CSR=4.91. CSR in Tide rinse water=6.86. CSR in 1.2% Bold wash=3.38. CSR in Bold rinse water=5.36.

### EXAMPLE 8

An aqueous solution of composition containing 65 weight percent of 60 BA/21MMA/10 HEMA/9MAA and 35 weight percent of 80 Sty/10MMA/10AA (1% backbone cross-linking with magnesium ions), was adjusted to pH 10.5 using aqueous 2% NaOH solution. Film swelled upon 20:1 dilution (vol:vol) yet retained integrity. Cubic swell ratio (CSR) in 0.6% Tide wash, CSR=6.86. CSR in Tide rinse water=27.0. CSR in 1.2% Bold wash=4.33. CSR in Bold rinse water=9.94.

### EXAMPLE 9

An aqueous solution of composition containing 50 weight percent of 35 BA/33Sty/7MMA/25MAA and 50 weight percent of 60BA/21MMA/10HEMA/10AA (1% backbone cross-linking with zinc ions), was adjusted to pH 10.5 using aqueous 2% NaOH solution. An aqueous solution of composition JLE-1983 (1% backbone cross-linking with calcium ions), was adjusted to pH 11.0 using aqueous 2% NaOH solution. An aqueous solution of composition JLE-1980 (1% backbone cross-linking with magnesium ions), was adjusted to pH 10.5 using aqueous 2% NaOH solution. The zinc cross-linked film disintegrated at 60° C. in 1.2% Bold in 20 min. The magnesium cross-linked film disintegrated at 60° C. in 1.2% Bold after 35 min. The calcium cross-linked film retained integrity at 60° C. in 1.2% Bold after 35 min. All films have good integrity and remained intact at 60° C. in 0.6% Tide after 35 min. All four non-disintegrating films swelled much more in rinse water upon 20:1 dilution (vol:vol)yet retained integrity and remained intact.

Cubic swell ratios are presented for selected ionic strength and base responsive polyelectrolytic compositions in Table 1.

TABLE 1
Cubic Swell Ratios for Ionic Strength and Base Responsive
Polyelectrolytic Compositions

| Polyelectrolyte | | |
|---|---|---|
| Wt. % | | |
| Monomers | Swelling Solution | CSR |
| 40 Sty/35 BA/ | 2.5 M NaOH | 1.46 |
| 9MMA/16MAA | 1.0 M NaGH | 1.64 |
| (Zn²⁺and NH₃ | 0.25 M NaOH | 2.89 |
| free) | 0.1 M NaOH | 3.91 |
| | Tap water | 11.0 |
| 40 Sty/35 BA/ | 2.5 M NaOH | 1.52 |
| 9MMA/16MAA | 1.0 M NaOH | 1.73 |
| (1% n-DDM) | 0.1 M NaGH | 8 (film disintegrated) |
| 40 Sty/35 BA/ | 1.0 M NaOH | 1.73 |
| 9MMA/16MAA | 0.1 M NaOH | Film dissolved |
| (1.5% n-DDM) | | |
| 20 Sty/35 BA/ | 2.5 M NaOH | 4.1 |
| 29MMA/16MAA | 0.1 M NaOH | Film dissolved |
| (1.5% n-DDM) | | |
| 20 Sty/35 BA/ | 2.5 M NaOH | 1.62 |
| 29MMA/16MAA | 1.0 M NaOH | 3.21 |
| | 0.1 M NaOH | 6.33 |
| | Tap water | >30 |
| 40 Sty/35 BA/ | 2.5 M NaOH | 1.33 |
| 7MMA/18MAA | 1.0 M NaOH | 1.42 |
| | 0.1 M NaOH | 4.1 |
| | Tap water | 11.02 |
| 41 Sty/34 BA/ | 2.5 M NaOH | 1.33 |
| 9MMA/16MAA | 1.0 M NaOH | 1.62 |
| | 0.1 M NaOH | 3.55 |
| | Tap water | 9.6 |
| 33 Sty/35 BA/ | 2.5 M NaOH | 1.39 |
| 7MMA/16MAA | 1.0 M NaOH | 2.46 |
| (1% LOFA) | 0.1 M NaOH | 7.59 |
| | Tap water | >100 |
| 32 Sty/35 BA/ | 2.5 M NaOH | 1.52 |
| 12MMA/21MAA | 1.0 M NaOH | 2.15 |
| (0.5% LOFA) | 0.1 M NaOH | 8.62 (dissolved) |
| | Tap water | dissolved |
| 33 Sty/35 BA/ | 2.5 M NaOH | 1.71 |
| 7MMA/25MAA | 1.0 M NaOH | 2.33 |
| (0.5% LOFA) | 0.1 M NaOH | Rapidly dissolved |
| JLE-1937 | 2.5 M NaOH | 1.16 |
| With 37 wt. % | 1.0 M NaOH | 1.62 |
| gelatin | 0.1 M NaOH, film pre- | 4.1 |
| | neutralized | |
| | 0.1 M NaOH, film un- | 4.1 |
| | neutralized | |
| | Tap water | 17.6 |

n-DDM is n-dodecylmercaptan, LOFA is linseed oil fatty acid.
Rhoplex ® B-1604 is a product of Rohm and Haas Company.

We claim:

1. A triggered response composition comprising: one or more polyelectrolytes in contact with an aqueous system that is stable and insoluble in an aqueous system at relatively high ionic strength equivalent to 0.5 M sodium chloride or higher or base concentration of between 1.0 M to 2.5 M or higher and that disperses, disintegrates, dissolves, destabilizes, swells, or combinations thereof, wherein the chemical/physical response of the composition is triggered upon one or more ionic strength or base strength changes to the aqueous system; wherein the polyelectrolyte is one or more alkali soluble polymers comprising: (a) 5-70 weight percent of acidic monomers selected from methacrylic acid, 2-methylpropionic acid or acrylic acid; (b) 30-95 weight percent of one or more non-ionic vinyl monomers selected from butyl acrylate, styrene and methyl methacrylate and optionally, (c) 0.01 to 5 weight percent of one or more metal cross-linking agents.

2. The triggered response composition according to claim 1 wherein the composition is stable and insoluble in an aqueous system at relatively high ionic strength or base strength and wherein the composition disperses, dissolves, swells or disintegrates in an aqueous system at relatively low ionic strength, base strength, dilution of the aqueous system or when the ionic strength of the aqueous system in contact with the composition is lowered.

3. A triggered response barrier composition comprising: one or more polyelectrolytes in contact with an aqueous system, wherein the polyelectrolyte is one or more alkali soluble polymers comprising: (a) 5-70 weight percent of acidic monomers selected from methacrylic acid, 2-methylpropionic acid or acrylic acid; (b) 30-95 weight percent of one or more non-ionic vinyl monomers selected from butyl acrylate, styrene and methyl methacrylate and optionally, (c) 0.1 to 5 weight percent of one or more metal cross-linking agents, wherein the barrier composition surrounds one or more active ingredients; wherein the barrier composition is stable and insoluble in an aqueous system at relatively high ionic strength or base strength; wherein the barrier exhibits one or more chemical/physical responses selected from dispersing, disintegrating, dissolving, destabilizing, swelling, softening, flowing and combinations thereof; wherein the chemical/physical response of the composition is triggered upon one or more ionic strength or base strength changes to the aqueous system; and wherein the barrier composition is capable of releasing the active ingredients to the aqueous system as a result of the triggered response.

4. The triggered response barrier composition according to claim 3 wherein the barrier composition is in the form of a film having particle diameters between 5 nm and 3000 μm.

5. The triggered response barrier composition according to claim 4 wherein the composition is prepared from at least one Morez® polymer having a weight average molecular weight between 1,000 and 20,000 and particle diameters between 5 nm to 300 μm.

6. A process for triggering the release of one or more active ingredients to an aqueous system comprising the steps of:
(a) surrounding one or more active ingredients with an ionic strength or base strength responsive barrier composition, wherein the composition includes one or more one or more alkali soluble polymers comprising:
(a) 5-70 weight percent of acidic monomers selected from methacrylic acid, 2-methylpropionic acid or acrylic acid; (b) 30-95 weight percent of one or more non-ionic vinyl monomers selected from butyl acrylate, styrene and methyl methacrylate and optionally, (c) 0.1 to 5 weight percent of one or more metal cross-linking agents the barrier being substantially impermeable to releasing the active ingredients to the aqueous system and remaining insoluble in the aqueous system; and
(b) altering the ionic strength or the base strength of the aqueous system;
wherein the barrier composition disperses, disintegrates, dissolves or swells and becomes substantially permeable, thereby triggering the release of the active ingredients into the aqueous system.

7. The process according to claim 5 wherein the barrier composition is in the form of a spray dried film prepared from at least one ASE emulsion polymer having a weight average molecular weight between 20,000 and 10,000,000 and particle diameters between 5 nm to 3000 μm.

8. The process according to claim 5 wherein the barrier composition is in the form of a film and the composition comprises a Morez® polymer having a weight average molecular weight between 1,000 and 20,000 and particle diameters between 5 nm to 300 μm.
